(19) United States
(12) Patent Application Publication
(10) Pub. No.: US 2011/0298295 A1
(43) Pub. Date: Dec. 8, 2011

(54) SYSTEM AND METHOD FOR PROVIDING POWER THROUGHOUT A STRUCTURE WITHOUT WIRING

(76) Inventor: Jeffrey S. Combs, Indianapolis, IN (US)

(21) Appl. No.: 13/152,672

(22) Filed: Jun. 3, 2011

Related U.S. Application Data
(60) Provisional application No. 61/351,075, filed on Jun. 3, 2010.

(51) Int. Cl. H01F 38/14

(52) U.S. Cl. 307/104

(57) ABSTRACT

A system and method for controlling the transmission, receipt and/or utilization of transmitted energy. Through the incorporation of various mechanisms, the disclosed system and method ensures that a particular power supply will provide energy to an appropriate electronic device.

### CROSS REFERENCE TO RELATED APPLICATIONS

This application claims the benefit of U.S. Provisional Application No. 61/351,075, filed Jun. 3, 2010, which is hereby incorporated by reference.

### BACKGROUND

The present invention generally relates to wireless energy transmission and more particularly, to a system and method for controlling the transmission, receipt, and/or utilization of energy which is wirelessly transmitted.

Since the advent of efficient production and delivery of alternating current (AC) electricity, humans have become more and more dependent upon electronics. Electronic devices are now used and relied upon in all facets in life: entertainment, business, utilities, etc. Because people are in an almost constant need for their electronic devices, those devices are in an almost constant need of available power.

Two known options are currently available to provide the power necessary to run and operate an electronic device. First, the device may be continually plugged into an AC wall power outlet through a power cord. Therefore, whenever the electronic device or appliance needs power, it is immediately available to it. However, the more devices are used, the more those power cords take up space around the home and office. Naturally, there is a desire to remove that clutter. Further, a significant amount of time and materials is required to provide multiple power outlets throughout a building. A system which would allow power to be effectively transmitted throughout a building, while also minimizing the construction costs, would be an improvement over known systems.

A second option to deliver power the electronic device is to have the device be battery powered. Batteries conveniently allow the user to freely use the electronic device without being tethered to a particular location by a power cord. However, battery operated devices are not without their drawbacks. Batteries are often expensive to produce and require periodic maintenance (i.e., charging) or replacement. Additionally, batteries also generate a considerable amount of pollution during their construction and disposal.

Thus, there is an important need in the field.

### SUMMARY

The principles of the present disclosure provide a system and method for controlling the transmission, receipt and/or utilization of transmitted energy. Through the incorporation of appropriate means and mechanisms, the disclosed system and method ensures that a particular power supply will provide energy to an appropriate electronic device.

In one aspect of the present disclosure, system for providing energy from a power supply to an electronic device comprises a first endec electrically connected to the power supply and a first transceiver communicatively connected to the first endec. The system further comprises a power relay electrically connected to the electronic device and a second endec communicatively connected to a second transceiver and operatively connected to the power relay. The second endec constructed and arranged to control the operation of the power relay.

In another aspect of the present disclosure, a system for providing energy from a power supply to an electronic device comprises a transmission coil constructed and arranged to communicate with a reception coil, as well as a first matching circuit electrically disposed between the power supply and the transmission coil. A transmission tuner is operatively connected to the first matching circuit and the transmission coil. The system further comprises a second matching circuit electrically disposed between the reception coil and the electronic device, and a reception tuner operatively connected to the second matching circuit and the reception coil.

According to one embodiment of the present disclosure, the transmission tuner and reception tuner are constructed and arranged to be manually adjusted.

According to another embodiment of the present disclosure, the transmission tuner and reception tuner are constructed and arranged to be automatically adjusted.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a block diagram of a typical wireless energy transmission system utilizing magnetic resonance.

FIG. 2 is illustrates two separate wireless power transmission systems located in different houses.

FIG. 3 is a block diagram of a wireless energy transmission system utilizing magnetic resonance according to one embodiment of the present disclosure.

FIG. 4 is a flow chart of a wireless energy transmission system according to one embodiment of the present disclosure.

FIG. 5 is a block diagram of a wireless energy transmission system utilizing magnetic resonance according to another embodiment of the present disclosure.

FIG. 6 is a block diagram of a wireless energy transmission system utilizing magnetic resonance according to a further embodiment of the present disclosure.

### DESCRIPTION OF THE SELECTED EMBODIMENTS

For the purposes of promoting an understanding of the disclosure, reference will now be made to the embodiments illustrated in the drawings and specific language will be used to describe the same. It will nevertheless be understood that no limitation of the scope of the disclosure is thereby intended, such alterations and further modifications in the illustrated device and its use, and such further applications of the principles of the disclosure as illustrated therein being contemplated as would normally occur to one skilled in the art to which the disclosure relates. It will be apparent to those skilled in the relevant art that some features that are not relevant to the present invention may not be shown for the sake of clarity.

The language used in the claims is to only have its plain and ordinary meaning, except as may be explicitly defined herein. Such plain and ordinary meaning is inclusive of all consistent dictionary definitions from the most recently published Webster's dictionaries and Random House dictionaries.

Systems have been developed which allow energy to be wirelessly transferred. Though the system will be described in more detail below, the most promising wireless energy transmission systems rely upon magnetic fields to wirelessly provide power to an electronic device. More specifically, these systems rely on magnetic coupling between two electromagnetic objects. In order to increase the effectiveness and efficiency of the wireless energy transmission, the objects are tuned such that the resonant frequencies are identical. The magnetic field generated by a tuned transmission coil interacts with a similarly tuned reception coil. Because the reception coil is electrically connected to an electronic device, the interaction provides power to the electronic device. Because only the magnetic field is being relied upon, the energy transmission system is safe as the magnetic field interacts weakly with any other surrounding objects, such as biological tissue. Further, the magnetic field is capable of transmitting power around objects or obstacles.

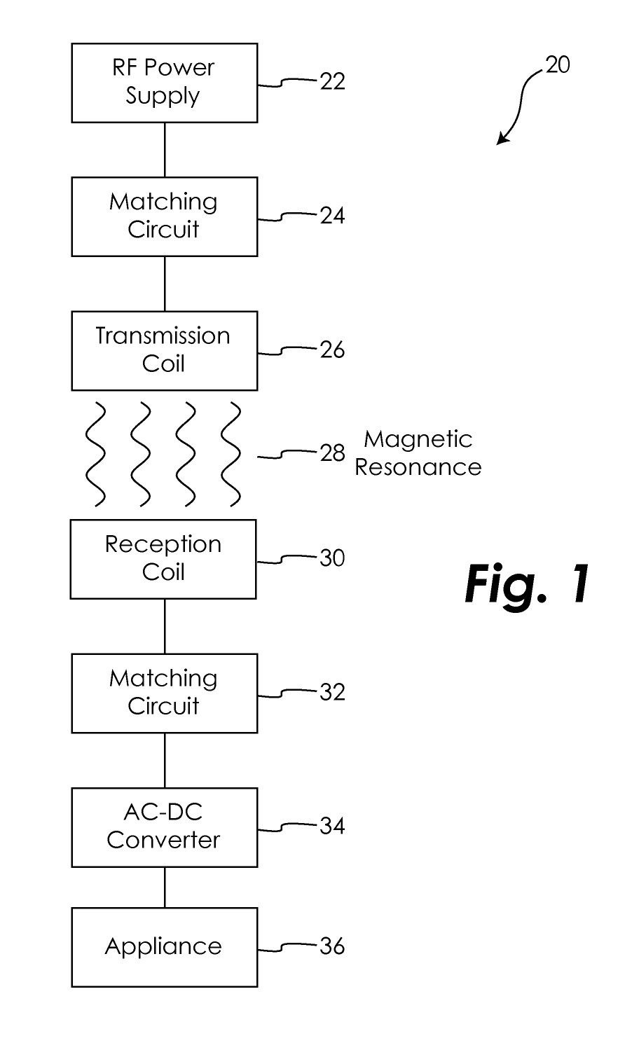

In order to provide the proper context of the embodiments of the present disclosure, FIG. 1 is a block diagram of a typical wireless energy transmission system utilizing magnetic resonance. The wireless energy transmission system 20 includes an RF power supply 22, matching circuit 24 and transmission coil 26. The RF power supply 22 provides AC energy through the transmission coil 26 in order to generate the requisite magnetic field. Matching circuit 24 is provided between RF power supply 22 and transmission coil 26 to properly match the impedance between the two components in order to efficiently provide energy to the transmission coil 36. The matching circuit 24 also properly feeds the AC energy to the transmission coil 26.

Spaced apart from the transmission coil 26 is a reception coil 30 which is electrically connected to matching circuit 32. The matching circuit 32 is in turn optionally connected to an AC-DC converter 34, which converts the AC energy received by the reception coil 30 into DC energy to be utilized by electric appliance or device 36. As appreciated by those skilled in the art, AC-DC converter 34 may be removed and the electronic appliance 36 may utilize the AC energy or include an internal AC-DC converter. Additionally, a DC-DC converter may be disposed between the AC-DC converter 34 and the electronic appliance 36 to step up or down the voltage to be utilized by the electronic appliance 36.

As described above, the underlining principle governing the energy transfer between transmission coil 26 and reception coil 30 is magnetic resonance coupling between the two coils, as generally denoted by number 28. Because the transmission coil 26 and reception coil 30 have a common resonant frequency, a significant amount of power can be transmitted from transmission coil 26 to reception coil 30.

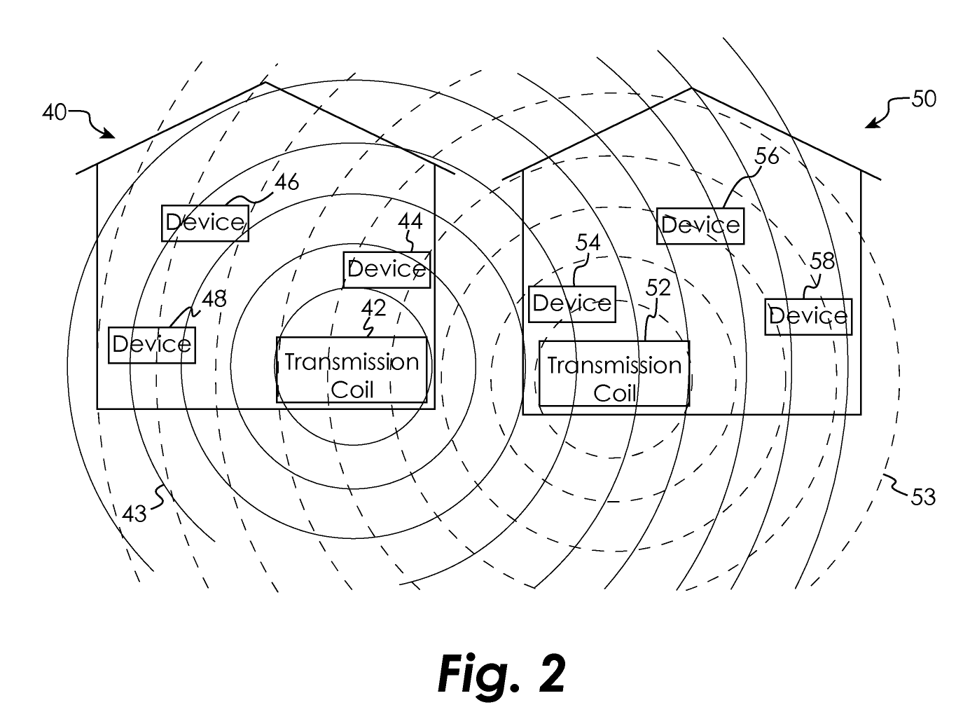

However, as the distance over which power may be transferred increases, so too are the potential problems associated with such systems. One problem is generally depicted in FIG. 2 which provides a block diagram of two separate wireless power transmission systems located in different houses. As depicted, house 40 utilizes a transmission coil 42 to wirelessly provide power to a variety of electronic devices 44, 46, 48. Power is provided from transmission coil 42 to devices 44, 46, 48 via a magnetic field, which is generally depicted by concentric rings 43. Similarly, house 50 utilizes transmission coil 52 to wirelessly provide power to electronic devices 54, 56, 58. Again, power is provided from transmission coil 52 to devices 54, 56, 58 via a magnetic field, generally depicted by concentric rings 53. As shown, the magnetic field 43 produced by transmission coil 42 clearly provides energy to all the electronic devices 44, 46, 48 within house 40 because they are within the range of magnetic field 43. With that being said, electric devices 54, 56, 58 are also within the range of magnetic field 43 and are capable of receiving power from transmission coil 42.

A problem therefore arises if the owner of house 50 realizes the situation and decides to take advantage of his or her neighbor's transmission coil 42 by allowing it to provide power to electronic devices 54, 56, 58. It may also be the case that electronic devices 54, 56, 58 are inadvertently powered by transmission coil 42. Regardless of intent, such situations should be avoided. Though the present disclosure discusses this problem in the context of neighboring houses, the same problem would present itself in a variety of settings, such as, but not limited to, adjacent apartments, offices, dorm rooms, etc. Various embodiments of the present disclosure ensure that an electronic device or appliance is powered by the appropriate transmission coil.

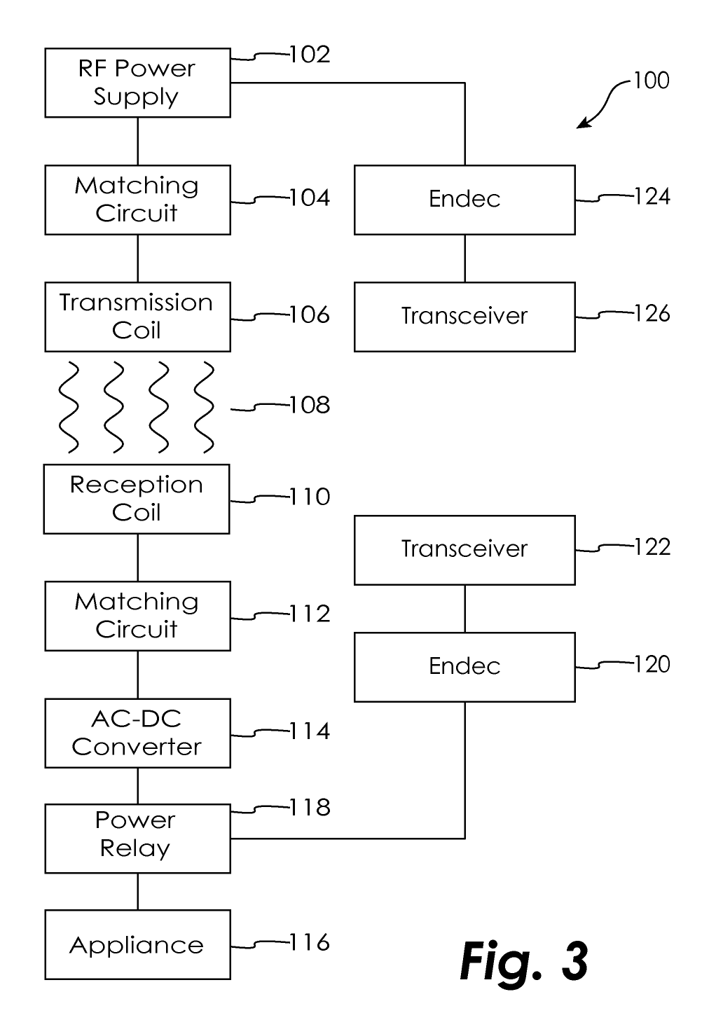

Turning now to FIG. 3, a system is provided to ensure that energy is properly transmitted, received, or otherwise utilized by an electronic device according to one embodiment of the present disclosure. Like system 20 of FIG. 1, wireless power transmission system 100 includes an RF power supply 102, matching circuit 104 and transmission coil 106. The RF power supply 102 provides AC energy through the transmission coil 106 in order to generate the requisite magnetic field. Matching circuit 104 is provided between RF power supply 102 and transmission coil 106 to properly match the impedance between the two components in order to efficiently provide energy to the transmission coil 26. The matching circuit 104 also properly feeds energy to the transmission coil 106.

Spaced apart from the transmission coil 106 is a reception coil 110 which is electrically connected to matching circuit 112. The matching circuit 112 is in turn optionally connected to an AC-DC converter 114, which converts the AC energy received by the reception coil 110 into DC energy to be utilized by electric appliance or device 116. As appreciated by those skilled in the art, system 20 may not include AC-DC converter 114, in which case electronic appliance 116 may utilize the AC energy or include an internal AC-DC converter. Additionally, a DC-DC converter may be disposed between the AC-DC converter 114 and the electronic appliance 116 to step up or down the voltage to be utilized by the electronic appliance 116.

Again, the underlining principle governing the energy transfer between transmission coil 106 and reception coil 110 is magnetic resonance coupling between the two coils, as generally denoted by number 108. Because the transmission coil 106 and reception coil 110 share a common resonant frequency, a significant amount of power can be transmitted from transmission coil 106 to reception coil 110.

Unlike system 20, however, wireless energy transmission system 100 includes mechanisms designed to ensure that transmission coil 106 provides energy to an appropriate electronic appliance 116. As depicted in FIG. 3, system 100 includes an endec (encoder/decoder) 124 which is electrically connected to RF power supply 102 and operatively and communicatively connected to transceiver 126. On the receiving end of system 100, a power relay 118 is positioned between AC-DC converter 114 and electrical appliance 116. A endec 120 is operatively and communicatively connected to power relay 118 and transceiver 122. Power relay 118 is constructed and arranged to either allow or block the transmission of DC voltage to applicance 116 based upon the signal received by transceiver 122 and analyzed by endec 120.

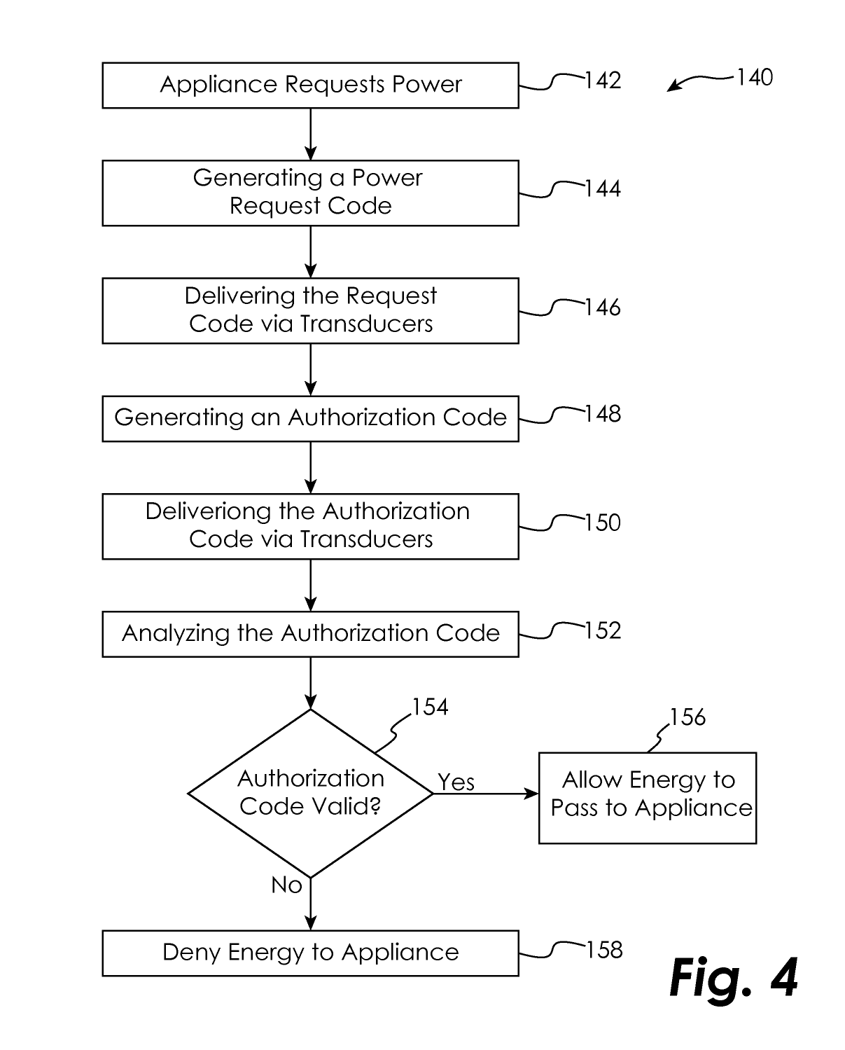

One illustrative embodiment of the operation of system 100 is depicted in FIG. 4. The process begins when appliance 116 requests power (step 142) and the power relay 118 relays that request to the endec 120. The endec 120 generates a power request code (step 144) which is transmitted via transceiver 122 (step 146). Upon receipt of that request code by transceiver 126, the endec 124 generates an authorization code (step 148). In some embodiments, endec 124 first decodes the power request code to ensure that the request originated from an associated electronic appliance 116 and/or endec 120. If the power request code is found not to be valid, no authorization code is delivered.

The generated authorization code is then sent by transceiver 126, received by transceiver 122 (step 150), and analyzed by endec 120 (step 152) to determine if the authorization code originated from an associated endec 124 (step 154). Because endec 124 and endec 120 are synchronized for the particular system 100, only certain authorization codes are determined by endec 120 and/or power relay 118 to be valid. If a valid authorization code is received, power relay 118 allows the DC energy to pass from AC-DC converter 114 to appliance 116 (step 156). If an invalid authorization code is received, power relay 118 blocks the DC energy from reaching appliance 116, thereby rendering appliance 116 inoperable (step 158).

In the illustrated embodiment, a power relay 118 is provided for each electronic appliance 116. In other embodiments, a single power relay is provided for all electronic appliances associated with a particular reception coil. As appreciated by those skilled in the relevant art, system 100 optionally includes a means to synchronize, or otherwise provide future valid authorization codes to, endec 124 and endec 120. In another embodiment, a DC-DC converter may be disposed between the AC-DC converter 114 and the electronic appliance 116 to step up or down the voltage to be utilized by the electronic appliance 116.

According to one embodiment of the present disclosure, endec 124 instructs RF power supply 102 to turn on and provide energy to transmission coil 108 upon receipt of the power request code by transceiver 126. In another embodiment, endec 124 instructs RF power supply 102 to turn on and provide energy to transmission coil 108 upon generation of an authorization code by endec 124. In other embodiments, such an instruction is unnecessary as RF power supply 102 continually provides energy to transmission coil 106.

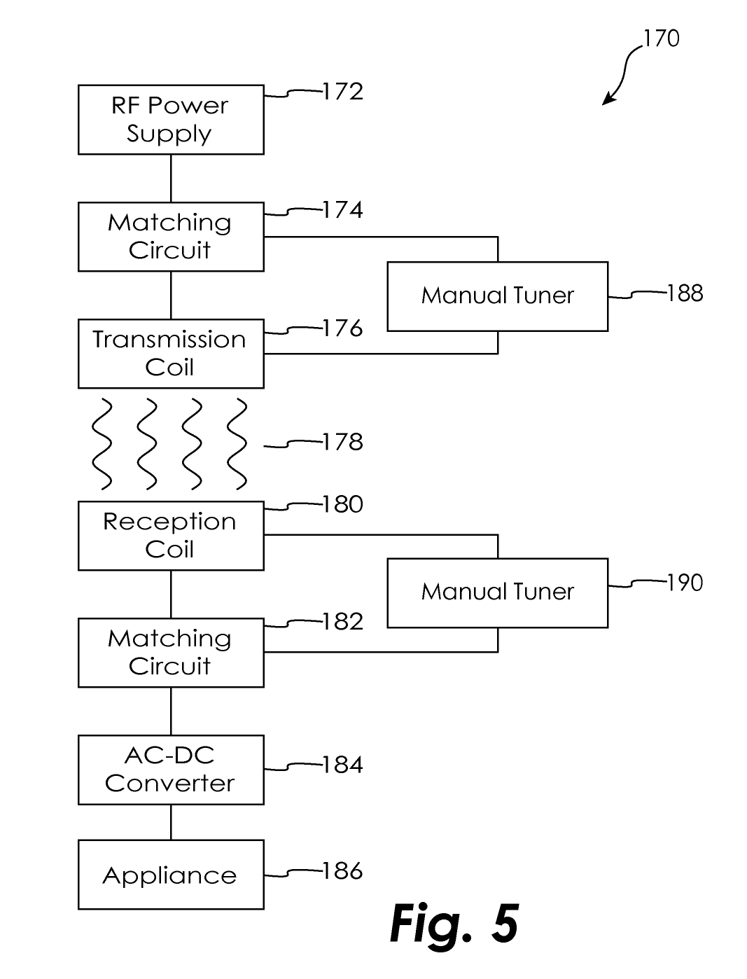

Referring now to FIG. 5, system 170 is a further embodiment of a wireless energy transmission system designed to ensure that energy is properly transmitted, received, or otherwise utilized by an electronic device. Similar to the previous systems, wireless power transmission system 170 includes an RF power supply 172, matching circuit 174, and transmission coil 176. The RF power supply 172 provides AC energy through the transmission coil 176 in order to generate the requisite magnetic field. Matching circuit 174 is provided between RF power supply 172 and transmission coil 176 to properly match the impedance between the two components in order to allow the energy to be efficiently transferred to transmission coil 176. The matching circuit 174 also properly feeds energy to the transmission coil 176.

Spaced apart from the transmission coil 176 is a reception coil 180 which is electrically connected to matching circuit 182. The matching circuit 182 is in turn connected to an AC-DC converter 184, which converts the AC energy received by the reception coil 180 into DC voltage to be utilized by electric appliance or device 186. System 170 may not include AC-DC converter 184, in which case electronic appliance 186 may utilize the AC energy or include an internal AC-DC converter. Additionally, a DC-DC converter may be disposed between the AC-DC converter 184 and the electronic appliance 186 to step up or down the voltage to be utilized by the electronic appliance 186.

Again, the underlining principle governing the energy transfer between transmission coil 176 and reception coil 180 is magnetic resonance coupling between the two coils, as generally denoted by number 178. Because the transmission coil 176 and reception coil 180 are resonant at a common frequency, a significant amount of power can be transmitted between the coils.

Unlike the previous systems, wireless transmission system 170 includes a manual tuner 188 operatively connected to both matching circuit 174 and transmission coil 176. Similarly, a manual tuner 190 is operatively connected to reception coil 180 and matching circuit 182. Manual tuners 188, 190 allow for the manual manipulation of the resonance frequency of the transmission and reception coils 176, 180, respectively. Because of the change in coil impedance due to the change in resonant frequency, manual tuners 188, 190 also provide an adjustment to the matching circuits 174, 182, respectively, in order to maintain an efficient transfer of energy between power supply 172 and transmission coil 176 or reception coil 180 and AC-DC converter 184.

According to one aspect of the present disclosure, the manual resonance tuner arrangement of system 170 allows for a particular resonance frequency to be selected by a homeowner and used throughout the house for each transmission and reception coil. Because the wireless energy transmission system is highly dependent upon matching resonance frequencies, neighboring wireless energy transmission systems will not interfere or otherwise receive the energy available by the transmission coil as the resonances are not likely to match. Due to the fairly wide range of frequencies available for wireless energy transfer and the sensitivity of the wireless energy transfer systems of mismatches in resonant frequencies, it would be difficult for an individual to identify the specific resonant frequency of the wireless energy transmission frequency selected by the homeowner and, therefore, improperly or inadvertently power his/her electronic devices.

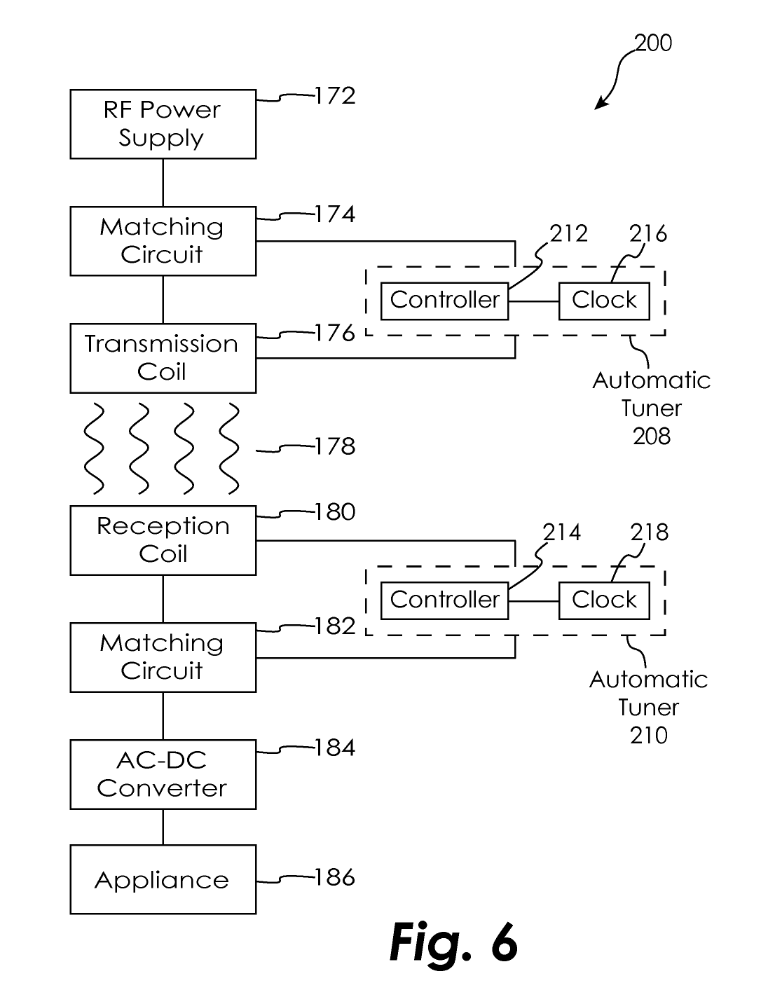

FIG. 6 depicts yet another wireless energy transmission system 200 designed to ensure that energy is properly transmitted, received, or otherwise utilized by an electric appliance. System 200 is substantially similar to system 170 of FIG. 5. For clarity, the components common to both systems are provided with the same reference numeral. As to the arrangement, functionality and purpose of those components, reference is made to the above discussion related to system 170.

However, instead of a manual resonance tuner, wireless energy transmission system 200 includes an automatic tuner 208 operatively connected to matching circuit 174 and transmission coil 176. Similarly, an additional automatic tuner 210 is operatively connected to reception coil 180 and matching circuit 182. Automatic tuners 208, 210 each include a controller 212, 214 and a clock 216, 218, respectively. Automatic tuners 208, 210 allow for a predetermined change and manipulation of the resonance frequency of the transmission and reception coils 176, 180, respectively. Because of the change in coil impedance due to the change in resonant frequency, automatic tuners 208, 210 also provide an automatic adjustment to the matching circuits 174, 182, respectively.

The automatic resonance tuner arrangement of system 200 allows for the matching resonance frequencies of the transmission coil 176 and reception coil 180 to be automatically changed. Similar to the frequency hopping techniques utilized by Bluetooth® technology, automatic tuners 208, 210 periodically change the resonant frequencies of the transmission coil 176, reception coil 180, and matching circuits 174, 182 in a pre-determined, through seemingly random, manner. Controllers 212, 214 and clocks 216, 218 are provided to ensure that the resonant frequencies of the coils 176, 180 stay matched. According to one embodiment of the present disclosure, automatic tuners 208, 210 also include means to resynchronize in the event that the resonance frequencies determined by the controllers 212, 214 become mismatched. The resynchronization means may include, but are not limited to, the delivery of instructional codes delivered via transceivers associated with the automatic tuners or a separate device which is physically connected to the automatic tuners to provide the resonant frequency sequence, just to name a couple of examples.

In other, non-illustrated embodiments, the wireless energy transmission system includes a gas powered generator. The generator is constructed and arranged to automatically generate power in the event the RF power supply fails to generate sufficient power to electrical appliance. In one embodiment, the generator is attached to the matching circuit. In another embodiment, the generator is attached to the transmission coil.

In other embodiments, the wireless energy transmission system includes an electronic panel to indicate the current conditions of the system. For example, the electronic panel may optionally indicate the amount of power generated at a given time, an indication of whether each appliance is synchronized to the system (i.e., red and green indicator lights), and/or generator information, such as the amount of fuel remaining and frequency of use. A communicative connection, such as a USB port, may optionally be provided for the user or service personnel to connect with the system, perform diagnostic checks and/or review historical data related to system usage and performance.

In further embodiments, the wireless energy transmission system is wirelessly monitored and controlled. In one embodiment, a user may wirelessly access the wireless energy transmission system and see which electric appliances are requesting and/or receiving power from the transmission coil. In another embodiment, a user may wireless turn an appliance on or off.

As used herein, the term “code” may refer to any digital communication, instruction and/or request. Though the depicted embodiments rely on digital communications, other embodiments may deliver instructions in an analog fashion as known by those of skill in the relevant art.

While the invention has been illustrated and described in detail in the drawings and foregoing description, the same is to be considered as illustrative and not restrictive in character, it being understood that only the preferred embodiments have been shown and described and that all changes and modifications that come within the spirit of the invention are desired to be protected. It is also contemplated that structures and features embodied in the present examples can be altered, rearranged, substituted, deleted, duplicated, combined, or added to each other. The articles “the”, “a” and “an” are not necessarily limited to mean only one, but rather are inclusive and open ended so as to include, optionally, multiple such elements.

What is claimed is:

1. A system for providing energy from a power supply to an electronic device, said system comprising:
a first endec electrically connected to said power supply;
a first transceiver communicatively connected to said first endec;
a power relay electrically connected to said electronic device;
a second transceiver; and
a second endec communicatively connected to said second transceiver and operatively connected to said power relay, said second endec constructed and arranged to control the operation of said power relay.

2. The system of claim 1 further comprising an AC-DC converter electrically connected to said power relay.

3. The system of claim 1, wherein said second endec is constructed and arranged to generate a power request.

4. The system of claim 3, wherein said second transceiver is constructed and arranged to communicate said power request to said first transceiver.

5. The system of claim 4, wherein said first endec is constructed and arranged to generate an authorization code based upon said power request.

6. The system of claim 5, wherein said first transceiver is constructed and arranged to communicate said authorization code to said second transceiver.

7. The system of claim 1 further comprising means to synchronize said first endec and said second endec.

8. A system for providing energy from a power supply to an electronic device, said system comprising:
a transmission coil constructed and arranged to communicate with a reception coil;
a first matching circuit electrically disposed between said power supply and said transmission coil;
a transmission tuner operatively connected to said first matching circuit and said transmission coil;
a second matching circuit electrically disposed between said reception coil and said electronic device; and
a reception tuner operatively connected to said second matching circuit and said reception coil.

9. The system of claim 8, wherein said transmission tuner is constructed and arranged to adjust the resonant frequency of said transmission coil, said reception tuner is constructed and arranged to adjust the resonant frequency of said reception coil.

10. The system of claim 8, wherein said transmission tuner and said reception tuner are constructed and arranged to be manually adjusted.

11. The system of claim 8, wherein said transmission tuner and said reception tuner are constructed and arranged to be automatically adjusted.

12. The system of claim 11, wherein said transmission tuner comprises a first controller and a first clock, said reception tuner comprises a second controller and a second clock.

13. The system of claim 12, wherein said first clock is synchronized to said second clock.

14. The system of claim 8, wherein said transmission tuner is constructed and arranged to adjust an electrical characteristic of said first matching circuit.

15. The system of claim 14, wherein said electrical characteristic is electrical impedance.

16. A method for providing energy from a power supply to an electrical appliance, said method comprising the steps of:
generating a power request code;
delivering said power request code from a first transceiver to a second transceiver;
generating an authorization code;
delivering said authorization code from said second transceiver to said first transceiver;
evaluating said authorization code.

17. The method of claim 16 further comprising the step of allowing energy to pass to said electronic appliance based on said evaluation of said authorization code.

18. The method of claim 16 further comprising the step of evaluating said power request code.

19. The method of claim 16 further comprising the step of turning on said power supply based upon receipt of said power request code.

20. The method of claim 16 further comprising the step of turning on said power supply based on generation of said authorization code.
